(19) United States
(12) Patent Application Publication
(10) Pub. No.: US 2011/0191952 A1
(43) Pub. Date: Aug. 11, 2011

(54) Cushioned bed pan

(76) Inventor: Tracy Brazier, Baltimore, MD (US)

(21) Appl. No.: 12/931,204

(22) Filed: Jan. 25, 2011

Related U.S. Application Data
(60) Provisional application No. 61/336,721, filed on Jan. 25, 2010.

(51) Int. Cl. A61G 9/00

(52) U.S. Cl. 4/456

(57) ABSTRACT

The Cushioned Bed Pan provides consumers a comfortable alternative to the standard stainless steel or plastic bedpans available on the market. As the name implies, The Cushioned Bed Pan is a specially designed bedpan featuring a generously padded, cushioned seat. Similar in size and function of a standard bedpan, The Cushioned Bed Pan is generally oval in shape and features an ample, built-in receptacle for collecting waste. As with traditional bedpans, The Cushioned Bed Pan features an integrated handle hidden flush against the underside of the seat and designed specifically to afford easy transport while also enabling caregivers to quickly and efficiently empty the device after use. The Cushioned Bed Pan is manufactured primarily of stainless steel and, in another embodiment, heavy duty plastic material. The most notable aspect of this device however, and that which sets this product apart from standard bedpans is found in the cushiony soft padding which encompasses the top of the unit. This padding is manufactured of synthetic foam, vinyl or similar material and provides a thick, cushiony barrier between the user and the hard seat, supporting the user's legs and buttocks in a comfortable and stable manner.

### CLAIM OF PRIORITY

This patent application claims priority under 35 USC 119 (e) (1) from U.S. Provisional Patent Application Ser. No. 61/336,721 filed Jan. 25, 2010, of common inventorship herewith entitled, “The Cushioned Bed Pan.”

### FIELD OF THE INVENTION

The present invention pertains to the field of bed pan apparatus, and more specifically to the field of cushioned bed pan apparatus.

### BACKGROUND OF THE INVENTION

The prior art has put forth several designs for cushioned bed pan apparatus. Among these are:

U.S. Pat. No. 3,728,744 to Exall L. Kimbro, Jr. and Clara D. Kimbro describes an apparatus to facilitate the use of bedpans for bedfast persons which includes an inflatable crescent or U-shaped cushion of rubber or other soft elastic material which, in inflated condition, is capable of elevating and supporting the sacro-coccygeal area of a patient higher above the plane of the bed than the height of a bedpan, and shaped to receive a bedpan between the legs of the crescent or U; said cushion supported on a flexible pad-like base large enough to fit under the hips of the patient and having sufficient rigidity to permit insertion under the patient with minimal manual lifting; and a bedpan adapted to slide into and fit snugly between the legs of the cushion.

U.S. Pat. No. 4,827,540 to Lillie M. Stokes describes a disposable combination bedpan cushion and waste bag assembly having a cushion top formed into the size and shape of the seat portion of a bedpan and including a center opening similar to that of the seat portion of the bedpan. The waste bag is permanently attached to the cushion top to enclose the center opening from below. The waste bag is sealed after use. The cushion top is formed from layers of plastic-backed adhesive, rigid plastic, and cotton padding. An inner rim is provided around the inner periphery of the center opening to allow the cushion top to snugly fit onto a seat of a bed pan.

U.S. Pat. No. 5,867,845 to Norine Fangmann describes an improved bedpan apparatus which is disclosed, including a bedpan having a base and a wall defining a receptacle, and a lip which can support a person; and a bedpan cushion coupled to the bedpan on the lip. The apparatus also can include a layer of material which provides frictional resistance to movement of the cushion on the lip.

U.S. Pat. No. 6,851,132 to Cynthia L. Jones-Lowe describes a padded seat provided, similar to a toilet seat that is attached or clipped to a conventional bedpan. Friction fit snaps are provided for attaching the padded cushion to a bedpan. The snap on/snap off design extends the versatility of existing bedpans while remaining easy to empty and clean.

None of these prior art references describe the present invention.

### SUMMARY OF THE INVENTION

It is an object of the present invention to provide a cushioned bed pan apparatus.

### BRIEF DESCRIPTION OF THE DRAWINGS

FIG. 1 is a right front perspective view of the device of the present invention.

FIG. 2 is a left front perspective view of the device of the present invention.

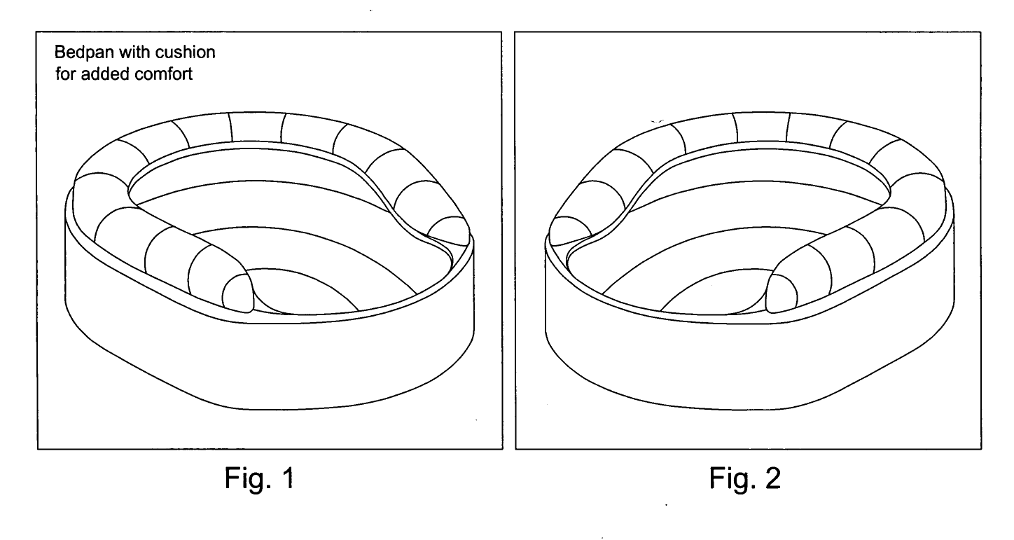

### DETAILED DESCRIPTION OF THE INVENTION

Perhaps one of the most challenging occupations within the medical profession has to do with the care of the elderly. Whether a doctor, nurse, or medical assistant, those who care for individuals living in nursing and convalescent homes must take special care to provide senior patients optimal medical treatment while taking into consideration the patient's special needs. Answering patients' call bells, delivering messages, serving meals and helping patients to eat, dress, and bathe, are but a few of the many tasks expected of personnel who work in assisted care facilities. In particular, nurses and aides also provide skin care to patients; take temperatures, pulse, respiration, and blood pressure, and help patients get in and out of bed and walk. Because of conditions brought on by age, disease, muscular degeneration and prescribed medications, many elderly patients regularly utilize bedpans as a safe alternative to traditional toilets. Bedpans are extremely practical devices utilized not only by the elderly, but by many able bodied hospital and medical patients who are recovering from surgery, bouts of illness or the birth of a child. Enabling the patient to use the facilities without first climbing out of bed and walking to the bathroom, bedpans are particularly useful for those recovering from broken bones, hip replacement surgery and similar maladies.

While there is little disputing that bedpans are practical and necessary devices, there is one major drawback associated with their use. Specifically, actually silting on a bedpan is quite uncomfortable for the patient. In particular, for elderly patients or those with brittle bones, bed sores or similar ailments, sitting for an extended period on a hard stainless steel or plastic bedpan is extremely taxing on the body. Because of the very nature of many ailments and injuries, the act of utilizing the facilities is time consuming and strenuous. Considering that most who utilize bedpans are already feeling ill or are in pain, it is unfortunate that they should be faced with the option of sitting on a hard, inflexible bedpan, simply in order to relieve themselves.

The present invention, hereinafter referred as The Cushioned Bed Pan, provides consumers a comfortable alternative to the standard stainless steel or plastic bedpans available on the market. As the name implies, The Cushioned Bed Pan is just that, a specially designed bedpan featuring a generously padded, cushioned seat. Similar in size and function of a standard bedpan, The Cushioned Bed Pan is generally oval in shape and features an ample, built-in receptacle for collecting waste. As with traditional bedpans, The Cushioned Bed Pan features an integrated handle hidden flush against the underside of the seat and designed specifically to afford easy transport while also enabling caregivers to quickly and efficiently empty the device after use. The Cushioned Bed Pan is manufactured primarily of stainless steel and, in another embodiment, heavy duty plastic material. The most notable aspect of this device however, and that which sets this product apart from standard bedpans is found in the cushiony soft padding which encompasses the top of the unit. This padding is manufactured of synthetic foam, vinyl or similar material and provides a thick, cushiony barrier between the user and the hard seat, supporting the user's legs and buttocks in a comfortable and stable manner.

Use of The Cushioned Bed Pan is very simple and straight forward. First, a nursing assistant or other experienced health care provider offers The Cushioned Bed Pan to his or her patient for use. Sliding the unit directly beneath the patient, the caregiver then allows the patient to utilize the unit as needed. After use, the caregiver removes The Cushioned Bed Pan via the integrated handle, emptying the unit and storing it away until again needed.

The Cushioned Bed Pan affords caregivers and their patients a number of significant benefits and advantages. Foremost, The Cushioned Bed Pan provides hospital and nursing home patients a simple and comfortable means of utilizing the facilities. Generously covered in cushiony soft padding, The Cushioned Bed Pan supports the weight of the body in a stable manner, without placing unnecessary strain on the muscles or bones. Providing an ample barrier between the user and the actual bedpan, the Cushion Bedpan enables patients to utilize the lavatory safely and in comfort.

Eliminating the strain and stress associated with sitting on a hard bedpan, The Cushioned Bed Pan allows consumers to relieve themselves, quickly and with ease. Doctors, nurses and other professional caregivers also appreciate the many benefits associated with The Cushioned Bed Pan. Easily handled and effortlessly emptied, The Cushioned Bed Pan offers health care providers a simple and convenient means of meeting the most basic needs of their patients. Manufactured of durable materials, The Cushioned Bed Pan withstands years of repeated use.

The Cushioned Bed Pan is a cleverly designed product invention that provides a physically challenged and bedridden consumer a convenient means of using the rest room. Simple-to-use, this practical product proves an invaluable accessory in any household, hospital or health care facility.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A cushioned bed pan apparatus, comprising:
a bedpan featuring a generously padded, cushioned seat, wherein the bedpan is similar in size and function to a standard bedpan, is generally oval in shape and features an ample, built-in receptacle for collecting waste, an integrated handle hidden flush against the underside of the seat.

2. The cushioned bed pan of claim 1 comprising stainless steel.

3. The cushioned bed pan of claim 1 comprising heavy duty plastic material.

4. The cushioned bed pan of claim 1 comprising cushiony soft padding which encompasses the top of the unit.

3. The cushioned bed pan of claim 4 wherein the padding is manufactured of synthetic foam, vinyl or similar material and provides a thick, cushiony barrier between the user and the hard seat, supporting the user's legs and buttocks in a comfortable and stable manner.
